(19) United States
(12) Patent Application Publication
(10) Pub. No.: US 2014/0007251 A1
(43) Pub. Date: Jan. 2, 2014

(54) METHOD FOR INTERCHANGING DATA IN A SECURE RUNTIME ENVIRONMENT

(71) Applicant: Stephan Spitz, Karlsfeld (DE)

(72) Inventor: Stephan Spitz, Karlsfeld (DE)

(21) Appl. No.: 14/001,332

(22) PCT Filed: Feb. 22, 2012
(86) PCT No.: PCT/EP12/00763

§ 371 Date: Sep. 17, 2013

(30) Foreign Application Priority Data
Feb. 24, 2011 (DE) 10 2011 012 227.3

(51) Int. Cl. G06F 21/60

(52) U.S. Cl. CPC G06F 21/606
USPC 726/26

(57) ABSTRACT

The invention relates to a method for interchanging data between a secure runtime environment (SWd), in which a number of secure applications (TL) can be executed, and a non-secure environment (NWd) of a microprocessor unit (MP), in particular in a mobile terminal, in which application data (AD) and control data (MCP, NQ) are transmitted via different buffers.

The invention relates to a method for interchanging data between a secure runtime environment, in which a number of secure applications can be executed, and a non-secure environment of a microprocessor unit, in particular in a mobile terminal.

Secure runtime environments are known from the prior art and make it possible to execute programs using a microprocessor unit in a manner protected against attacks. In this case, a microprocessor unit should be understood as meaning all of the hardware used to execute programs, in particular the actual microprocessor as well as corresponding volatile and non-volatile memories which are used to store data when executing programs.

In order to comply with the security requirements, the storage restrictions and communication mechanisms of microprocessor units with secure runtime environments, it is necessary to optimize a multitasking property.

The object of the present invention is to specify a method for interchanging data between a secure runtime environment and a non-secure environment of a microprocessor unit, which method enables an improved multitasking property. Another object of the invention is to specify a microprocessor unit having improved multitasking properties.

These objects are achieved by a method according to the features of patent claim 1 and a microprocessor unit according to the features of patent claim 13. Advantageous refinements of the invention are specified in the dependent patent claims.

In the method according to the invention for interchanging data between a secure runtime environment, in which a number of secure applications can be executed, and a non-secure environment of a microprocessor unit, in particular in a mobile terminal, application data and control data are transmitted via different buffers.

This enables strict process isolation which makes it possible to securely download binary code. Furthermore, it is possible to more quickly interchange data between applications in the non-secure environment and processes in the secure runtime environment.

It is preferred if different types of control data are transmitted via different buffers. It is likewise preferred if monitoring data relating to the changeover between the secure runtime environment and the non-secure environment are transmitted via a separate secure buffer. It is possible to change between the secure runtime environment and the non-secure environment using the monitoring data. This makes it possible to achieve, in particular, fast context change times, thus resulting in good performance in the event of a task change between processes.

In another expedient refinement, the transmission of the application data and the control data and optionally the monitoring data is based on an ARM monitor code implemented in a monitor unit having interfaces to the secure runtime environment and the non-secure environment.

It is also preferred if the application data and the control data are transmitted between the secure runtime environment and a driver of the non-secure environment. A scheduler implemented in the non-secure environment, in particular in an interface of the driver for the control data, expediently stipulates which of the secure applications is executed in the secure runtime environment.

It is also expedient if the data are interchanged using a memory area of a memory, which memory area can be read and/or written to by the secure runtime environment and the non-secure environment. The memory area is preferably initialized by a monitoring message. In this case, in particular, provision is made for the runtime environment secured using control messages to be informed of data in the memory area which are intended for said environment. In this case, the control data are preferably provided with a unique session identifier (session ID) which can be used by the secure runtime environment to assign the control message to one of the applications executed in the secure runtime environment.

In another advantageous refinement, a defined computation time which cannot be exceeded is allocated to each process running in the secure runtime environment. This computation time must not be exceeded for security reasons. This makes it possible to achieve strict process isolation.

According to another expedient refinement, the process running in the secure runtime environment has the following thread structure: thread identifier (ID); current state of the thread; local exception handler for the threads; priority of the thread. A respective process preferably has the following task structure: current state of the task; task identifier of the generator task; external exception handler for the task; computation time quota for the task; number of threads which can be activated or provided by the task; priority and rights of the task. As a result of the thread and/or task structures described, there is no need to copy over large quantities of data in the event of a context change. This makes it possible to achieve fast context change times.

The invention also provides a microprocessor unit with a secure runtime environment and a non-secure environment, which unit is configured in such a manner that application data and control data are transmitted via different buffers in order to interchange data between the secure runtime environment and the non-secure environment. In this case, the term “microprocessor unit” should be broadly understood again and includes all hardware components needed to interchange data, for example a portable data storage medium and, in particular, a chip card.

The invention also relates to a mobile terminal, in particular a cell phone, comprising a corresponding microprocessor unit.

The invention is explained in more detail below using exemplary embodiments in the drawing, in which:

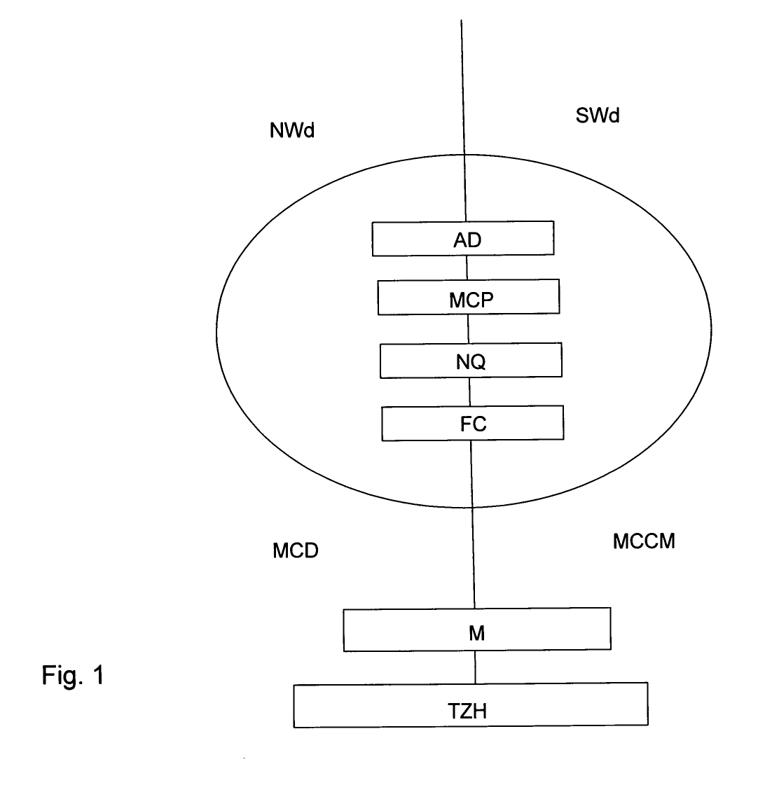

FIG. 1 shows a schematic illustration of the method according to the invention,

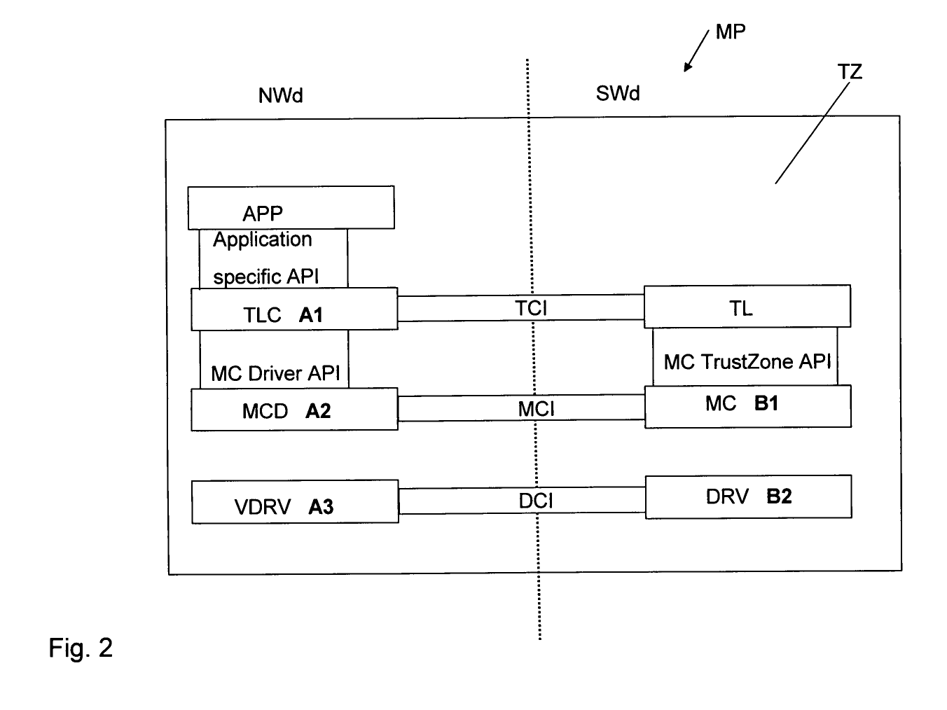

FIG. 2 shows a schematic illustration of the components of a microprocessor unit which are needed to implement the method according to the invention,

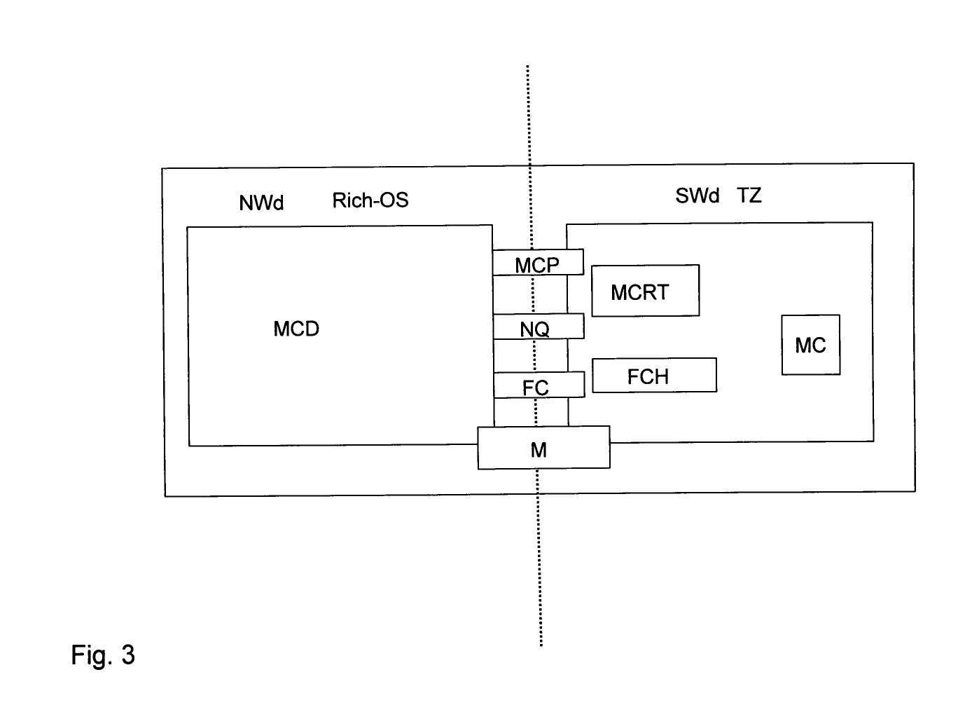

FIG. 3 shows a schematic illustration used to explain the method of operation of the method according to the invention, and

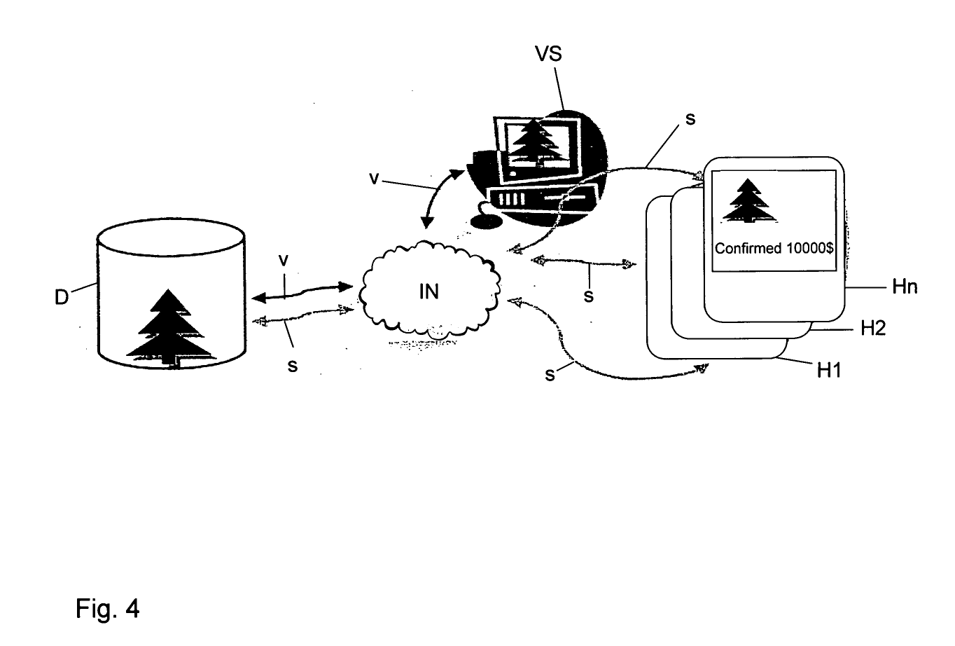

FIG. 4 shows a schematic illustration of an exemplary application of the method according to the invention.

FIG. 1 is used to describe the interchange of data between a secure runtime environment SWd and a non-secure environment NWd of a microprocessor unit which is in the form of a so-called ARM trust zone. The ARM trust zone is a known technology used to generate, in a microprocessor unit, a protected area which is used as a secure runtime environment SWd for executing applications referred to as trustlets. The secure runtime environment is referred to as the “Secure World” and the non-secure environment is referred to as the “Normal World”. In the embodiment described here, the ARM trust zone is implemented on a hardware platform, the so-called trust zone hardware, of a mobile terminal, for example a cell phone. In this case, the runtime environment is a software layer between the application layer and the operating system layer of the microprocessor unit.

FIG. 1 schematically shows such a microprocessor unit with a secure runtime environment SWd having a communication unit MCCM which is in the form of a so-called MobiCore communication module. In this case, the communication unit MCCM uses the operating system MC (MobiCore) of the secure runtime environment SWd. The non-secure environment NWd with a driver MCD which is in the form of a so-called MobiCore driver is also illustrated. Rich OS is used as the operating system. The secure runtime environment SWd and the non-secure environment NWd are implemented in so-called trust zone hardware TZH.

A monitor unit M is provided for the purpose of interchanging data between the secure runtime environment SWd and the non-secure environment NWd. Application data AD, control data MCP (MobiCore control protocol data), control data NQ (notification queue) and monitoring data FC (so-called fast calls) are transmitted via respective different buffers. The transmission of the application data AD, the control data MCP and NQ and the monitoring data FC is based on ARM monitor code implemented in the monitor unit M having interfaces to the secure runtime environment SWd and the non-secure environment NWd.

FIG. 2 shows the components of a microprocessor unit MP which are needed to implement the method according to the invention. Said microprocessor unit has the secure runtime environment SWd (already described) and the non-secure environment NWd. The secure environment is also referred to as a trust zone TZ. The latter contains at least one application which is referred to as a trustlet TL. Said application communicates with an operating system of the secure runtime environment MC, for example MobiCore, (block B1) via an application-specific interface (MC trustlet API). The secure runtime environment SWd also contains drivers DRV (block B2).

At least one application APP which can interchange data with an application connector TLC (so-called trustlet connector) in block A1 via an application-specific interface (application-specific API) is provided in the non-secure environment which uses Rich OS, for example, as the operating system. The application connector can communicate with an application TL in the secure runtime environment via an interface TCI. The non-secure environment NWd also contains a driver MCD, for example a MobiCore driver, in a block A2, which driver is assigned an application-specific interface (MC driver API). The non-secure environment also contains a virtual driver VDRV in a block A3. The MobiCore driver MCD can communicate with the operating system MC of the secure runtime environment via an interface MCI. Communication between the virtual driver VDRV and the driver DRV of the secure runtime environment is possible via an interface DCI.

Inventive properties of the microprocessor unit are an outsourced process scheduler in the non-secure environment in the MobiCore driver MCD. The operating system of the secure runtime environment, for example MobiCore, contains an optimized microkernel which does not comprise any inter-process communication, for example. Pre-emptive multitasking with time quotas is carried out in MC. MC also comprises an optimized task context. Finally, the microprocessor unit comprises a multilayer driver concept in blocks A1, A2, A3 which are optimized for asynchronous communication with an environment capable of multitasking in B1.

The multilayer driver concept is explained in more detail below using FIG. 3. The MobiCore driver MCD (block A2) is constructed as illustrated in FIG. 3 and comprises three interfaces for transmitting control data MCP and NQ and monitoring data FC between the non-secure environment and the secure runtime environment SWd. A runtime management unit MCRT and a monitoring data handler FCH are also provided in the MobiCore operating system (block B1). The monitor unit M (already mentioned at the outset) for coordinating the interchange of data between the secure runtime environment SWd and the non-secure environment NWd is also illustrated.

The interface assigned to the transmission of the control data MCP is mainly responsible for controlling the MobiCore operating system MC. Here, a decision is made regarding which tasks of the operating system are started and stopped. The data provided by the MobiCore operating system are checked for the correct formatting. For communication, a special buffer is reserved in a memory and is initialized via a monitoring message FC. The memory is referred to as world shared memory. Said memory can be accessed both by the non-secure environment NWd and by the secure runtime environment SWd.

The interface assigned to the transmission of the control data NQ is responsible for using messages to inform the runtime management unit MCRT that data are ready for collection in the memory. These data may come from the MobiCore driver MCD, that is to say belong to the data communication between an application in the non-secure environment NWd and a particular application (trustlet TL) in the secure runtime environment SWd. In the case of communication on the layer of the MobiCore driver MCD, the messages are provided with an identifier, a so-called session ID, which can be used by the MobiCore operating system MC to uniquely assign the message to a particular application TL in the secure runtime environment SWd.

Control data from the layer of the control data MCP may likewise be in the buffer for the control data NQ. In both cases, the interface assigned to NQ informs the runtime management unit MCRP of the triggering of a special interrupt (preferably a special trust zone interrupt SIQ) using provided data.

The actual change between the non-secure environment NWd and the secure runtime environment SWd takes place via the interface assigned to the monitoring data FC. In this respect, there are three possible ways of interacting with the monitor unit M: via so-called fast calls, N-SIQ messages or NQ-IRQ messages. The latter are referred to as notification IRQ. The first two change over only from the non-secure environment to the secure runtime environment. In the case of NQ-IRQs, it is also possible to change over in the opposite direction.

The interface assigned to the control data MCP undertakes the task of the scheduler in the MobiCore driver MCD of the non-secure environment. The driver decides which MobiCore task is executed.

The concept described enables optimizations in the microkernel approach. In comparison with conventional microkernel approaches, no inter-process communication IPC is implemented in the MobiCore operating system MC. Nevertheless, MobiCore processes can interchange data via a commonly used memory (world shared memory). MobiCore processes are also allocated a particular computation time which cannot be exceeded for security reasons.

A MobiCore process has simple thread and task structures. As a result, there is no need to copy large quantities of data in the event of a context change. This results in fast context change times.

The thread structure is as follows: thread ID, current state of the thread, local exception handler for the threads, priority of the thread. The task structure is as follows: current state of the task, task ID of the generator task, external exception handler for the task, computation time quota for the task, number of threads which can be activated or donated by the task, priority and rights of the task.

The transmission of application data, control data and monitoring data via different buffers can be used for the application illustrated in FIG. 4.

An application in a secure area of a cell phone H1, H2, . . . , Hn communicates with a central background system (database D) and receives, from there, an item of information for representation on the display of the security mode. The information to be represented may be, for example, a column of numbers, an image, a logo etc. The background system D modifies the information to be represented in the security mode at regular intervals. The information to be represented is additionally publicly disclosed to a wide circle of users at the same time. The user of the terminal H1, H2, . . . , Hn, which comprises a secure display apparatus, can check the currently valid information via a second communication channel. The second communication channel may be, for example, an Internet-enabled computer, the browser of the cell phone, which comprises a web link from the secure world, a daily newspaper etc.

The protection of security-critical data, for example cryptographic keys, is hereby not in the foreground. Instead, the user perception of a secure display or a secure input means is important here. As a result, the confidence of end users in mobile terminals, for example for mobile bank applications or payment applications, can be increased.

For this purpose, the database system D stores information which is interchanged in the terminals H1, H2, . . . , Hn using an update server implemented in the terminals via an update client of the database. In FIG. 4, the information is a Christmas tree, for example. The same information is also made available to publicly arbitrary verification systems VS using a web server integrated in the database system via a public channel v. The sequence of updating the information is as follows:
1. The update server makes contact with all mobile terminals H1, H2, . . . , Hn listed in the database D via a secure channel s in order to send a new item of information. This means that the background system modifies the information to be represented in the security mode of the mobile terminal H1, H2, . . . , Hn at regular intervals.
2. In order to carry out a successful update, the update client must be authenticated with the update server in the terminal. This may be effected using a client certificate, for example. The update server of the terminal must also likewise prove to the update client of the database that contact has been made with the correct server for the update. This can be effected using a server certificate.
3. Following successful mutual authentication, the new information (here: Christmas tree) is loaded into the terminal in an area which is accessible only to the security mode via the secure channel s between the update server of the handheld devices and the update client of the database.
4. The information is optionally protected with a digital watermark and is personalized for each terminal.
5. The personalization can be checked in the secure runtime environment, for example. If it is not appropriate for the terminal, particular functionalities of the secure runtime environment are blocked. This results in no mobile payment operations being possible, for example.

The sequence of verification by the end user is as follows:
1. The end user carries out an action which switches the mobile terminal H1, H2, . . . , Hn to a security mode.
2. The relevant mobile terminal now displays an arbitrary item of information, here the Christmas tree, at a particular location on the secure screen.
3. The user of the terminal can now check, via a second parallel channel, whether the information on his mobile terminal corresponds to the information published elsewhere.

This increases the confidence of the end user in a cell phone, especially for payment and bank applications. Attacks which feign a security state of an electronic terminal are made considerably more difficult. The user is able to check whether the mobile device is in the security mode. This results in higher confidence of the user in the abovementioned applications.

1. A method for interchanging data between a secure runtime environment (SWd), in which a number of secure applications (TL) can be executed, and a non-secure environment (NWd) of a microprocessor unit (MP), in particular in a mobile terminal, in which application data (AD) and control data (MCP, NQ) are transmitted via different buffers.

2. The method as claimed in claim 1, characterized in that different types of control data (MCP, NQ) are transmitted via different buffers.

3. The method as claimed in claim 1, characterized in that monitoring data (FC) relating to the changeover between the secure runtime environment (SWd) and the non-secure environment (NWd) are transmitted via a separate secure buffer.

4. The method as claimed in claim 1, characterized in that the transmission of the application data (AD) and the control data (MCP, NQ) and optionally the monitoring data (FC) is based on an ARM monitor code implemented in a monitor unit (M) having interfaces to the secure runtime environment (SWd) and the non-secure environment (NWd).

5. The method as claimed in claim 1, characterized in that the application data (AD) and the control data (MCP, NQ) are transmitted between the secure runtime environment (SWd) and a driver (MCD) of the non-secure environment (NWd).

6. The method as claimed in claim 5, characterized in that a scheduler implemented in the non-secure environment (NWd), in particular in an interface of the driver (MCD) for the control data (MCP), stipulates which of the secure applications (TL) is executed in the secure runtime environment (SWd).

7. The method as claimed in claim 1, characterized in that the data are interchanged using a memory area of a memory (WSM), which memory area can be read and/or written to by the secure runtime environment (SWd) and the non-secure environment (NWd).

8. The method as claimed in claim 7, characterized in that control messages are used to inform the secure runtime environment of data in the memory area which are intended for said environment.

9. The method as claimed in claim 8, characterized in that the control messages are provided with a unique session identifier which can be used by the secure runtime environment (SWd) to assign the control message to one of the applications (TL) executed in the secure runtime environment (SWd).

10. The method as claimed in claim 1, characterized in that a defined computation time which cannot be exceeded is allocated to each process running in the secure runtime environment (SWd).

11. The method as claimed in claim 10, characterized in that a respective process has the following thread structure: thread identifier (ID); current state of the thread; local exception handler for the threads; priority of the thread.

12. The method as claimed in claim 10, characterized in that a respective process has the following task structure: current state of the task; task identifier of the generator task; external exception handler for the task; computation time quota for the task; number of threads which can be activated or provided by the task; priority and rights of the task.

13. A microprocessor unit with a secure runtime environment (SWd) and a non-secure environment (NWd), which unit is configured in such a manner that application data (AD) and control data (MCP, NQ, FC) are transmitted via different buffers in order to interchange data between the secure runtime environment (SWd) and the non-secure environment (NWd).

14. The microprocessor unit as claimed in claim 13, characterized in that the unit is configured in such a manner that it can be used to carry out a method for interchanging data between a secure runtime environment (SWd), in which a number of secure applications (TL) can be executed, and a non-secure environment (NWd) of a microprocessor unit (MP), in particular in a mobile terminal, in which application data (AD) and control data (MCP, NQ) are transmitted via different buffers, wherein different types of control data (MCP, NQ) are transmitted via different buffers.

15. A mobile terminal comprising a microprocessor unit as claimed in claim 13.
